(19) United States
(12) Patent Application Publication
(10) Pub. No.: US 2018/0035710 A1
(43) Pub. Date: Feb. 8, 2018

(54) WATER PIPE CONVERTER

(71) Applicants: David Desi ROBLES, San Pedro, CA (US); Rocco Anthony PATERNO, Orange, CA (US)

(72) Inventors: David Desi ROBLES, San Pedro, CA (US); Rocco Anthony PATERNO, Orange, CA (US)

(21) Appl. No.: 15/663,764

(22) Filed: Jul. 30, 2017

Related U.S. Application Data
(60) Provisional application No. 62/494,286, filed on Aug. 3, 2016.

(51) Int. Cl. A24F 1/30; F16L 33/00; F16K 27/06

(52) U.S. Cl. CPC A24F 1/30; F16K 27/06; F16L 33/00

(57) ABSTRACT

A water pipe converter advantageously converts a standard, single person water pipe (or similar device) into a device that can be utilized by multiple users. The converter has a truncated cone shaped plug, which fits into the orifice of the water pipe. A plurality of hoses are fitted into the apertures or holes of the plug, thereby allowing all users to be connected to the water pipe at the same time.

### PRIORITY APPLICATION

This patent application claims priority to and receives benefit from U.S. Provisional patent application filed on Aug. 3, 2016, entitled “WATER PIPE CONVERTER”, having Ser. No. 62/494,286. The U.S. Provisional patent application is hereby incorporated by reference in its entirety.

### FIELD OF DISCLOSURE

The present disclosure is in the technical field of water pipes, bongs and hookahs. More particularly, the present disclosure relates to any device by which a smoker inhales the product of combustible contents in an apparatus that may allow smoke to be drawn through it, in an object similar to a pipe, hookah, or water pipe, before being inhaled by the user.

### BACKGROUND

Hookahs are often bulky, oddly shaped, large objects made partly of sensitive materials, which can be fragile and may break easily. Hookahs are often very expensive and breaking one is very easy to do because of the materials used, the size and shape of the apparatus, as well as the height and weight distribution. Many hookahs are often made with only one or two connections and don't allow for several users to use it at the same time. Water pipes are also often times fragile and are intended for single users only and cannot be shared.

### SUMMARY OF THE INVENTION

The present disclosure generally relates to a converter. More specifically, the invention is a water pipe converter to allow for multiple users to use, e.g., a water pipe or a bong, at the same time. The converter allows for multiple users to draw smoke from, e.g., the water pipe or a bong, at the same time.

According to one aspect, the water pipe converter allows the user to easily convert water pipes, bongs, pipes (or bottles/devices with similar functions) that were originally designed for a single user, to be converted into a smoking apparatus designed for multiple users, similar to a hookah pipe that has the capability for multiple attachments.

According to one aspect, the converter, e.g., a multi-stemmed device, can quickly and simply be inserted and removed from the orifice of a variety of sized water pipes or bongs and will allow the user to conveniently have the option of smoking alone or with multiple people.

Because most hookah apparatuses, which only sometimes allow for multiple users, are often expensive, large, fragile, bulky and oddly shaped, they are difficult to transport, easy to break and not available to many consumers due to the high cost. Also, many hookahs do not offer more than one or two attachments at most and are not typically designed to allow for several users. In addition, most water pipes are designed for single users as well so there is very little opportunity for the consumer to have the opportunity to smoke with others existent in the marketplace, thus it has been limited to an activity that most are forced to do alone.

The present disclosure describes a converter that is affordable, transportable, compact, safe, and simple to use. Specifically, the converter can convert standard water pipes to a device that allows for multiple users, rather than one single user, to draw smoke from the water pipe at the same time.

The converter comprises of three parts; the first is a truncated cone shaped plug that fits securely in the orifice of most water pipes, and similar smoking apparatuses, to allow for an airtight seal. This plug can have a plurality of openings or apertures which can connect with two or more hoses with tips that serve as mouthpieces at the end. The second part of the converter are the hoses which are inserted into the top of the truncated cone shaped plug. The hoses can be inserted at one end of the plug facing the user when the plug is inserted into the orifice of a water pipe. The hose can extend at least partially or completely into the plug to form the connection with the plug. The hose and the tip together serve as a conduit or duct to allow the smoke to travel from the water pipe to the user through said hoses. The third part of the converter includes the tips which serve as mouthpieces for the users and connect to the hoses at the proximal end. These three parts comprise the basic components of the invention.

### BRIEF DESCRIPTION OF THE DRAWINGS

FIG. 1 is a top view of the truncated cone shaped plug showing holes that have a wider proximity to one another than FIG. 5.

FIG. 2 is a side perspective view of the truncated cone shaped plug and shows the top and bottom location of the openings.

FIG. 3 is a top/side view of the truncated cone shaped plug that shows the top of the plug with holes that have a wider proximity to one another than FIG. 5 and a portion of the side of the plug.

FIG. 4 is a side perspective view of the inside of the truncated cone shaped plug as if it were cut in half and includes a view of the interior holes or cutouts of the plug.

FIG. 5 is a top view of the truncated cone shaped plug with holes that have a narrower proximity to one another along the top side of the plug than in FIG. 1.

FIG. 6 is a side prospective view of the truncated cone shaped plug that shows the top and bottom locations of the openings.

FIG. 7 is a view of the truncated cone shaped plug, the three connected hoses that fit into the plug and the tips that connect to the ends of the hoses which is a total representation of how the invention looks when placed in its designated location at the orifice of the water pipe.

### DETAILED DESCRIPTION OF THE INVENTION

The water pipe converter comprises three main parts. The first is a truncated cone shaped food grade quality silicone (or similar material) plug that fits securely in the orifice of most water pipes and other similar smoking apparatuses allowing for an airtight seal. This plug will have a plurality of openings or apertures which will connect two or more food grade quality PVC (or similar material) hoses with aluminum/metal (or similar materials) tips that serve as mouthpieces at the end of each hose. The second part of the converter are the hoses which are inserted into the top of the truncated cone shaped plug at one end of the plug facing the user when the plug is inserted into the orifice of a water pipe. The distal end of the hoses connect to the plug. The hoses connect the plug and the tips together while serving similarly as a conduit or duct to allow the smoke to travel from the water pipe to the user through said hoses. The third part of the converter includes the metal tips (or similar material), which serve as mouthpieces for the users. The proximal end of the hoses connect to respective tips. These three parts comprise the basic components of the converter.

The converter is a solution which is affordable, compact, safe, and simple. The converter converts standard water pipes to devices that allow for multiple users, rather than just one single user. Because most water pipes are designed for single users there is no opportunity to smoke with others similarly to certain hookah pipes which sometimes offer additional attachments. Moreover, even most hookahs are only designed for one or two users, whereas this invention can have several.

The converter allows users the opportunity to have a compact, easy-to-use, affordable, safe simple tool that can easily be inserted and removed into the orifice of an average-sized water pipe designed for a single user, and instantly convert it into a smoking apparatus designed for multiple users, similar to a hookah device with multiple attachments, allowing the user to conveniently have the option of smoking alone or with multiple people.

The converter allows the consumer to circumvent having to purchase an expensive, large, fragile, bulky and oddly shaped water pipe or hookah that are often times only designed for one user, difficult to transport, easy to break and not available or practical to many consumers because of size, fragility and cost.

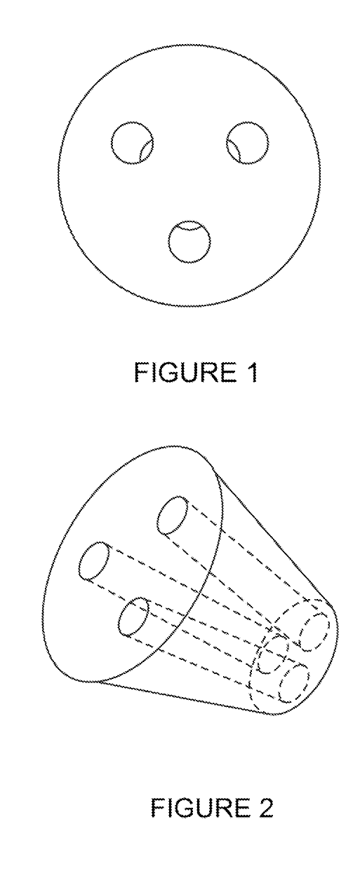

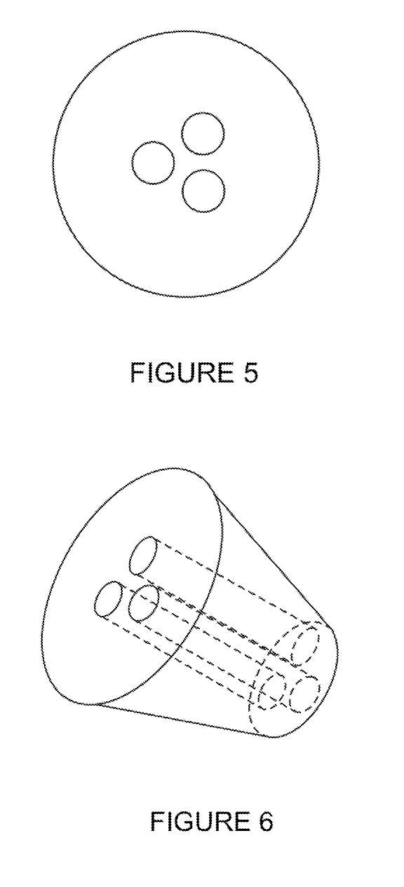

FIG. 1 illustrates a top view of the truncated cone shaped plug showing holes that have a wider proximity to one another than FIG. 5 for the embodiment of the three or four hose version of the converter. In this examples, three holes run through the plug. Generally speaking, the converter can have two or more holes running through the plug. The holes are angled, and do not run exactly parallel to each other.

FIG. 2 illustrates a side perspective view of the truncated cone shaped plug and shows the top and bottom location of the openings. The plug is capable to be fitted into most water pipe orifices with standard openings (even with varying sizes) and will allow for an airtight seal to ensure that air flow is only passed via the hoses that are inserted into the plug.

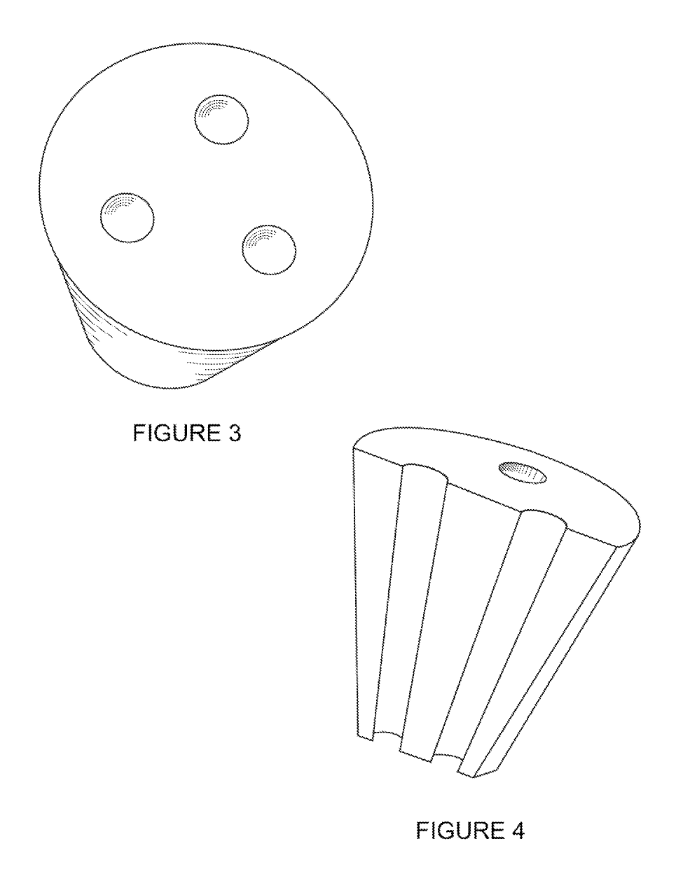

FIG. 3 illustrates a top/side view of the truncated cone shaped plug that shows the top of the plug with holes that have a wider proximity to one another than FIG. 5 for the embodiment of the three or four hose version invention, as well as a portion of the side of the plug.

FIG. 4 illustrates a side perspective view of the inside of the truncated cone shaped plug as if it were cut in half and includes a view of the interior holes or cutouts of the plug. Each of the hoses (i.e., a portion of the hose) is placed in each of the holes with a snug fit. The hoses allow for maximum air flow and personal control over how much smoke is consumed through each hose.

FIG. 5 illustrates a top view of the truncated cone shaped plug with holes that have a narrower proximity to one another along the top side of the plug as in FIG. 1. Closer/narrower proximity can allow for more openings in the plug and thus, more hoses and connections (thus more users) than the three or four hose embodiment. In this example, the three holes run through the plug. Generally speaking, the converter can have two or more holes running through the plug. The holes are not angled, and run substantially parallel with each other. When the holes are not angled, it might be easier to manufacture than when the holes are angled, where machinery has to be adjusted to have different angles to make the holes.

FIG. 6 illustrates a side prospective view of the truncated cone shaped plug that shows the top and bottom locations of the openings with holes that have a narrow proximity to one another along the top side of the plug, which can allow for more openings in the plug and thus, more hoses and connections (thus more users) than the three or four hose embodiment.

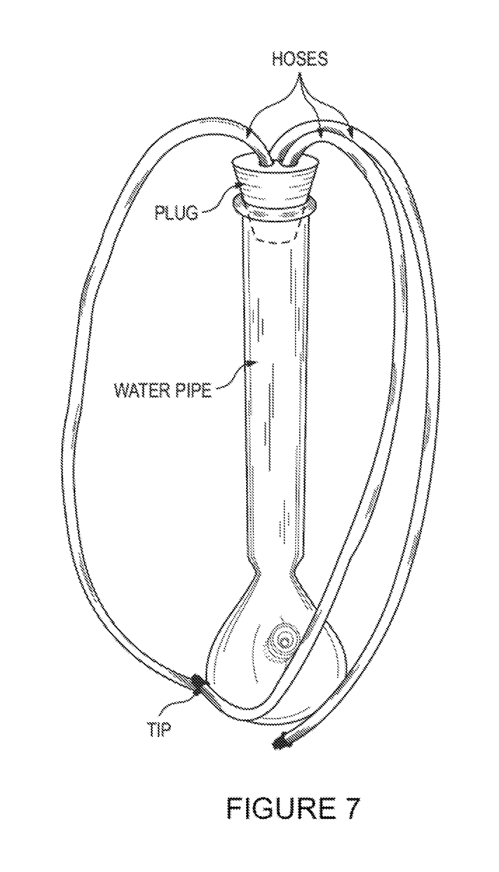

FIG. 7 illustrates a view of the truncated cone shaped plug (labeled plug), the three connected hoses (labeled hoses) that fit into the plug and the tip (labeled tip) that connect to the ends of each of the hoses. FIG. 7 shows the converter when it is placed in its designated location at the orifice/opening of the water pipe. The water pipe, such as the one shown in FIG. 7, generally has a chamber, a bowl for receiving combustible substance, and an orifice to the chamber. The plug to be used with the water pipe can be constructed using various materials and can be made in various sizes. The converter can be inserted in order to serve as a plug at the orifice or opening of the water pipe in order to create an airtight seal whereas the smoke is directed into all of the hoses. The hoses serve as a connection to allow the smoke to travel independently from the water pipe, through the plug and hoses and to the user. The hoses and tips can be made in various finishes, colors, materials and sizes.

Numerous other changes, substitutions, variations, alterations, and modifications may be ascertained to one skilled in the art and it is intended that the present disclosure encompass all such changes, substitutions, variations, alterations, and modifications as falling within the scope of the disclosure. Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also imperative to note that all of the specifications, dimensions, and relationships outlined herein (e.g., the number of hoses, etc.) have only been offered for purposes of example and teaching only. Such information may be varied considerably without departing from the spirit of the present disclosure. The specifications apply only to one non-limiting example and, accordingly, they should be construed as such. In the foregoing description, example embodiments have been described with reference to exemplary arrangements. Various modifications and changes may be made to such embodiments without departing from the scope of the present disclosure. The description and drawings are, accordingly, to be regarded in an illustrative rather than in a restrictive sense.

Note that with the numerous examples provided herein, interaction may be described in terms of two, three, four, or more parts or components. However, this has been done for purposes of clarity and example only. It should be appreciated that the system can be consolidated in any suitable manner. Along similar design alternatives, any of the illustrated elements of the FIGURES may be combined in various possible configurations, all of which are clearly within the broad scope of this Specification. It should be appreciated that the converter of the FIGURES and its teachings are readily scalable and can accommodate various number of components, as well as more complicated/sophisticated arrangements and configurations. Accordingly, the examples provided should not limit the scope or inhibit the broad teachings of the components as potentially applied to a myriad of other structures.

What is claimed is:

1. A water pipe converter comprising:
a truncated cone shaped plug, wherein the truncated cone shaped plug has a plurality of openings; and
a plurality of hoses, each hose having a first end connected to a respective opening.

2. The water pipe converter of claim 1, further comprising:
a plurality tips as mouth pieces;
wherein each hose has a second end connected to a respective tip.

3. A water pipe comprising:
an orifice; and
a water pipe converter comprising a truncated cone shaped plug sized to provide an airtight seal with the orifice and a plurality of hoses connected to openings of the truncated cone shaped plug.
